(19) United States
(12) Patent Application Publication
(10) Pub. No.: US 2021/0349193 A1
(43) Pub. Date: Nov. 11, 2021

(54) TIME OF FLIGHT APPARATUS AND METHOD

(71) Applicant: Sony Semiconductor Solutions Corporation, Kanagawa (JP)

(72) Inventors: Luca Cutrignelli, Brussels (BE); Markus Kamm, Karlsruhe (DE); Victor Belokonskiy, Zaventem (BE); Luc Bossuyt, Ghent (BE); Alexis Vander Biest, Brussels (BE)

(73) Assignee: Sony Semiconductor Solutions Corporation, Kanagawa (JP)

(21) Appl. No.: 17/282,357

(22) PCT Filed: Oct. 8, 2019
(86) PCT No.: PCT/EP2019/077142

§ 371 Date: Apr. 1, 2021

(30) Foreign Application Priority Data
Oct. 8, 2018 (EP) 18199050.8

(51) Int. Cl. G01S 7/4865; G01S 7/481; G01S 17/894; G01B 11/22

(52) U.S. Cl. CPC G01S 7/4865; G01S 7/4814; G01B 11/22; G01S 17/894; G01S 7/4816

(57) ABSTRACT

A time-of-flight apparatus has: a telecentric lens; a wavelength filter; and a light detection portion, wherein the wavelength filter is adapted to the telecentric lens.

### TECHNICAL FIELD

The present disclosure generally pertains to a time-of-flight apparatus and system and to a method of providing a time-of-flight apparatus and system.

### TECHNICAL BACKGROUND

Generally, time-of-flight (ToF) systems are known, which are used for determining a distance to or depth map of a region of interest.

In some instance, sun light or other ambient light sources limit the performance of a ToF system, since ambient shot noise caused by ambient light is typically a main noise source in ToF systems, which are used outdoor or in a sunny indoor environment or in an environment with other (strong) ambient light sources.

In order to reduce the amount of sunlight (or other strong ambient light sources) which may enter a ToF light sensor, it is known to use an IR (infrared) or NIR (near infrared) filter, which only passes infrared light and filters other wavelengths than infrared light, such that noise generated by sunlight may be reduced.

Although there exist ToF systems, it is generally desirable to provide a ToF apparatus or system and a method for providing a ToF apparatus or system.

### SUMMARY

According to a first aspect, the disclosure provides a time-of-flight apparatus, comprising a telecentric lens; a wavelength filter; and a light detection portion, wherein the wavelength filter is adapted to the telecentric lens.

According to a second aspect, the disclosure provides a method for providing a time-of-flight system, wherein the time-of-flight system includes a telecentric lens, a wavelength filter and a light detection portion, the method comprising adapting the wavelength filter to the telecentric lens.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 illustrates an embodiment of a ToF system;

FIG. 2 a) and b) illustrate different positions of a wavelength filter in an optical stack;

FIG. 3 a) and b) illustrate different AOI distributions for different wavelength filter positons as of FIG. 2 a) and b).

FIG. 4 a) illustrates a common lens system;

FIG. 4 b) illustrates a telecentric lens;

FIG. 5 a) illustrates an AOI distribution for the common lens system of FIG. 4 a);

FIG. 5b) illustrates an AOI distribution for the telecentric lens of FIG. 4b);

FIG. 6a) illustrates a SNR distribution of different wavelength filters for the common lens system of FIG. 4a);

FIG. 6b) illustrates a SNR distribution of different wavelength filters for an embodiment using the telecentric lens of FIG. 4b);

FIG. 7 is a flowchart of an embodiment of a method for providing a ToF system;

FIG. 8 illustrates a ToF camera; and

FIG. 9 schematically shows the telecentric lens system of the ToF camera of FIG. 8 including a sensor.

### DETAILED DESCRIPTION OF EMBODIMENTS

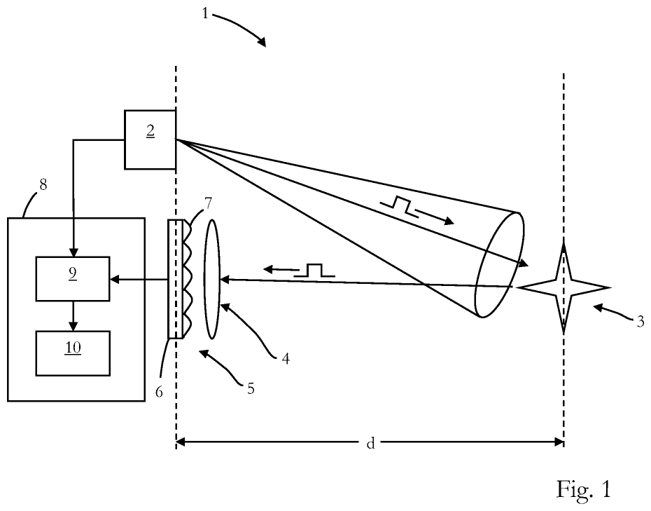

Before a detailed description of the embodiments under reference of FIG. 1 is given, general explanations are made.

As mentioned in the outset, it is generally known to use an infrared (IR) filter in a time-of-flight (ToF) system for reducing the noise generated by, for example, sunlight.

However, it has been recognized that a performance of IR filters may have a strong dependency on an angle of incidence (AOI) of incident light. Hence, it has been recognized that by designing or providing a wavelength filter with a narrow IR filter pass-band around the IR active light emission wavelength, a part of the active light received from a region of interest may be suppressed. Moreover, it has been recognized that in some instances the AOI increases at the corner of an image sensor of the ToF system and that active light having a higher AOI may be filtered out by the IR filter.

Hence, some embodiments pertain to a time-of-flight apparatus, including a telecentric lens; a wavelength filter; and a light detection portion, wherein the wavelength filter is adapted to the telecentric lens. Some embodiments pertain also to a method for providing a time-of-flight system, wherein the time-of-flight system includes a telecentric lens, a wavelength filter and a light detection portion (and, thus, may include the time-of-flight apparatus described herein), wherein the method includes adapting the wavelength filter to the telecentric lens. The following description pertains to the time-of-flight system, apparatus and method for providing the time-of-flight system or apparatus.

The telecentric lens may be an image-space telecentric lens, which may be an optical system (including multiple lenses) that has a CRA (chief ray angle) of approximately zero degrees across the whole image height.

The light detection portion may include or be an image sensor or photo detection sensor which is configured to detect light received from a region of interest, where light is scattered which originates from a light source, as it is generally known for ToF systems. The light detection portion may be based on known imaging technologies, such as CMOS (Complementary Metal Oxide Semiconductor), CCD (Charged Coupled Device), SPADs (Single Photon Avalanche Diodes), or the like, and it may include one or more photodiodes based on, for example, at least one of these technologies. The light detection portion has a light sensitive area.

The wavelength filter is adapted to the telecentric lens. For example, such an optical system, i.e. the telecentric lens, allows dimensioning the IR filter on a more limited bundles of AOIs, since the telecentric lens basically provides a chief ray angle of approximately zero degrees across the whole image height, such that the AOI does not or only increases less at the corner or edge of an wavelength filter compared to cases wherein no telecentric lens is used, as it is known for common ToF systems.

The wavelength filter may have a filter band in the infrared or near infrared range, wherein the infrared range may be within the interval of 1 mm to 780 nm wavelength and a near infrared range may be within the interval of 780 nm to 1400 nm wavelength without limiting the present disclosure in that regard.

A more selective (IR) wavelength filter may guarantee a better ambient light rejection in some embodiments and the performance may be equally good in the center and in the corners of the image sensor.

Image-space telecentric lenses have not been used in known ToF system, and, moreover, typically a short total track length is typically targeted for the optical system of known ToF systems, but in some embodiments the total track length is not or only slightly increased by designing a telecentric lens accordingly and tailoring it to the typically needs of ToF systems/apparatus as will also be apparent from the following discussion.

In some embodiments, the wavelength filter is adapted to the telecentric lens, based on a predetermined signal-to-noise ratio value. For instance, the signal-to-noise ratio may be predetermined for the ToF apparatus and may take into account a specific amount of ambient (e.g. sun) light. As mentioned, a telecentric lens has typically a chief ray angle of about zero degrees across the image height and, thus, it may not be necessary to compensate for increasing AOI at the corner or edge of the wavelength filter as it is known for known ToF systems or the compensation is much smaller compared to known ToF systems.

In some embodiments, the ToF apparatus further includes a lens system, wherein the telecentric lens is part of the lens system and wherein a position of the wavelength filter is adapted, based on a predetermined signal-to-noise ratio value, such as the predetermined signal-to-noise ratio value discussed above.

In some embodiments, the wavelength filter is adapted, based on an angle of incidence caused by the telecentric lens. As discussed, the telecentric lens, typically may have a CRA (chief ray angle) of approximately zero degrees across the whole image height, such that the AOI may not or may only very slightly increase or vary across the light sensitive area of the light detection portion and across the area of the wavelength filter which corresponds to this light sensitive area. Hence, the wavelength filter may be adapted to only take into account none or such small variations of the AOI.

In some embodiments, the wavelength filter is adapted to be basically uniform in its wavelength filtering characteristics, wherein the wavelength filter may be adapted to be basically uniform in a boundary region, such as the edges and or corners of the wavelength filter (or balanced out between the filtering characteristics in a center region in a boundary regions). As discussed, the telecentric lens may have a CRA (chief ray angle) of approximately zero degrees across the whole image height, such that the AOI may not or may only very slightly increase or vary across the light sensitive area, such that also the AOI in the boundary region may not vary or may only slightly vary, and, thus, the wavelength filter characteristic may by uniform for the whole wavelength filter and also for the boundary region.

In some embodiments, the time-of-flight apparatus further includes a microlens array arranged on the light detection portion, wherein the microlens array has basically a uniform spacing. As discussed, in known ToF systems, the AOI may increase in the edge, corner or boundary regions of the image sensor and in order to compensate for that effect, typically the spacing of the microlens array is adapted accordingly for regions with changing AOI. As in the present embodiments, a telecentric lens is provided, the spacing of the microlens array can be kept uniform or constant, since such an adaptation for increasing (or changing) AOI, in particular, at edges may be superfluous, and, thus the microlens is adapted to have a basically uniform spacing of the microlenses.

In some embodiments, the time-of-flight apparatus or system further includes a light source, wherein the light source has a wavelength band, which is adapted to the wavelength filter. For instance, be providing a light source, which has a narrow band, e.g. in the (near) infrared range, the wavelength filter characteristic can be adapted accordingly, since it may only have to further reduce the wavelength to a small infrared band or a small (near) infrared band, etc.

The light source may include LEDs (Light Emitting Diodes), laser elements (e.g. VCSEL, Vertical Cavity Surface Emitting Lasers) and it may include laser elements, which emit light in a narrow band, e.g. narrow (near) infrared band.

In some embodiments, the light source may have a small temperature dependency and/or the temperature dependency is taken into account for the optimization of the system.

As discussed, some embodiments pertain to a method for providing such a time-of-flight system or apparatus as discussed above, wherein providing may involve designing, implementing, generating, producing, manufacturing or the like of the associated time-of-flight system or apparatus.

Moreover, the ToF system may include circuitry for processing and analyzing the detection signals generated by the ToF apparatus and it may be configured to control the ToF device accordingly.

The ToF system (apparatus) may provide a distance measurement, may scan a region of interest and may provide depth maps/images or the like from the region of interest.

The ToF apparatus or system may be used in different technology applications, such as in Automotive, Gaming applications (e.g. gesture detection), as well as in smart phones or other electronic devices, such as computers, laptops, or in medical device, etc.

Returning to FIG. 1, there is illustrated an embodiment of a time-of-flight (ToF) system 1, which can be used for depth sensing or providing a distance measurement.

The ToF system 1 has a pulsed light source 2 and it includes light emitting elements (based on laser diodes), wherein in the present embodiment, the light emitting elements are narrow band laser elements.

The light source 2 emits pulsed light to an object 3 (region of interest), which reflects the light. By repeatedly emitting light to the object 3, the object 3 can be illuminated, as it is generally known to the skilled person. The reflected light is focused by an optical stack 4 to a light detector 5.

The light detector 5 has an image sensor 6, which is implemented based on multiple SPADs (Single Photon Avalanche Diodes) and a microlens array 7 which focuses the light reflected from the object 3 to the image sensor 6 (to each pixel of the image sensor 6).

The light emission time information is fed from the light source 2 to a circuitry 8 including a time-of-flight measurement unit 9, which also receives respective time information from the image sensor 6, when the light is detected which is reflected from the object 3. On the basis of the emission time information received from the light source 2 and the time of arrival information received from the image sensor 6, the time-of-flight measurement unit 9 computes a round-trip time of the light emitted from the light source 2 and reflected by the object 3 and on the basis thereon it computes a distance d (depth information) between the image sensor 6 and the object 3.

The depth information is fed from the time-of-flight measurement unit 9 to a 3D image reconstruction unit 10 of the circuitry 8, which reconstructs (generates) a 3D image of the object 3 based on the depth information received from the time-of-flight measurement unit 9.

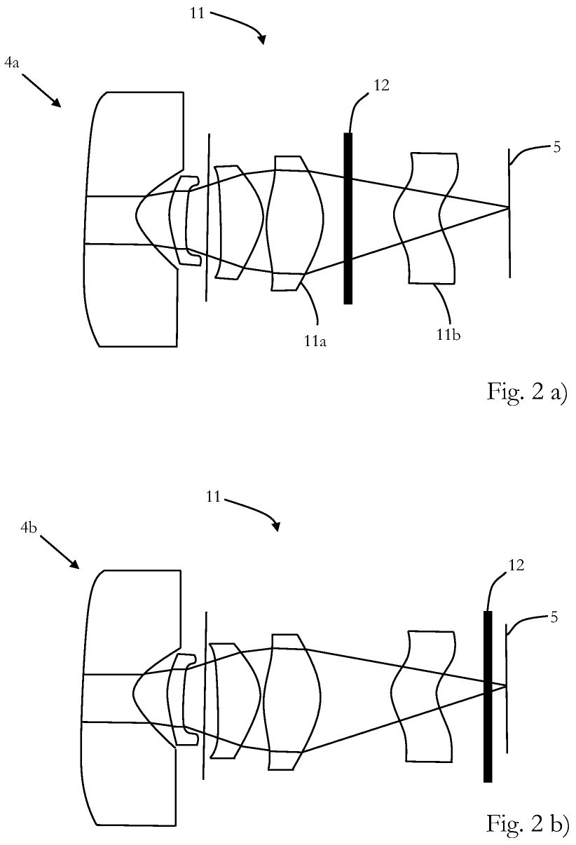

As mentioned above, the optical stack 4 includes a telecentric lens and a wavelength filter and FIG. 2 illustrates two different examples for an optical stack, a first optical stack 4a in FIG. 2a) and a second optical stack 4b in FIG. 2b), each having a telecentric lens 11 and a wavelength filter 12, wherein the two optical stacks 4a and 4b differ only in the position of the wavelength filter 12. In the case of the optical stack 4a (FIG. 2a)), the optical wavelength filter 12 is positioned between two lenses 11a and 11b of the telecentric lens 11 (which are the last two lenses next to the photo detector 5), while in the case of the optical stack 4b (FIG. 2b)), the optical wavelength filter 12 is positioned after the last lens 11b of the telecentric lens 11 which is next to the photo detector 5, such that the wavelength filter is positioned between the telecentric lens and the photo detector 5.

The distribution of the AOI received by the wavelength filter 12 depends on the position of the wavelength filter 12 within the telecentric lens or with respect to the telecentric lens. Hence, depending on a specific lens stack for a certain position of the wavelength filter, the wavelength filter is adapted to the distribution of the AOI received by the wavelength filter at that position. This means that the position of the wavelength filter 12 may also influence the overall system performance.

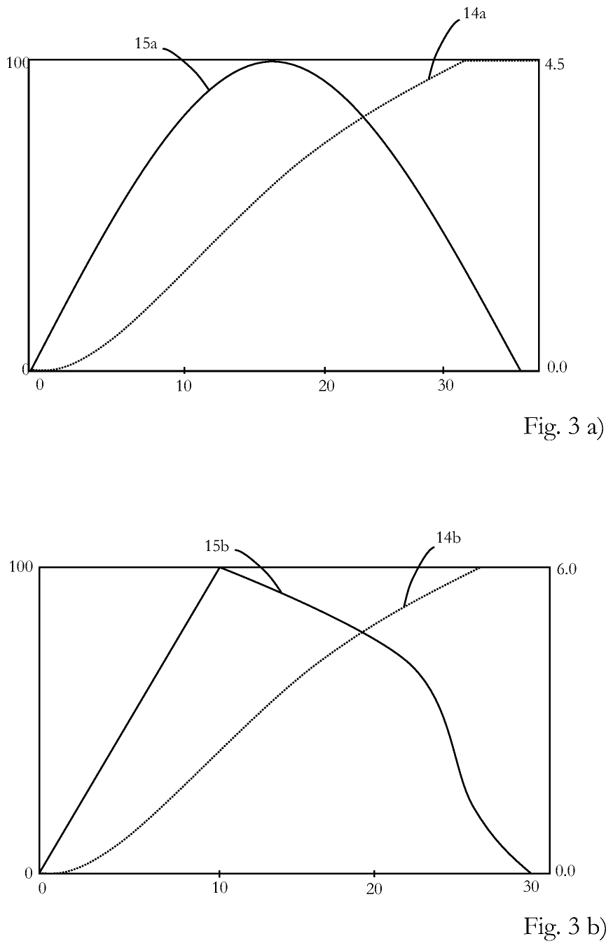

FIG. 3 illustrates on the upper side, FIG. 3a), the AOI distribution for the case of the optical stack 4a (FIG. 2a)) and on the down side the AOI distribution for the case of the optical stack 4b (FIG. 2b)). Each of the Figs. shows on the abscissa the AOI, while on the left ordinate which is associated with curve 14a, and 14b, respectively, the cumulative percentage of measured rays is illustrated (from 0% to 100%) and on the right ordinate the percentage of rays at a specific AOI is illustrated, which is associated with the curves 15a and 15b, respectively.

As can be taken from FIG. 3a), in the case where the wavelength filter 12 is positioned between lenses 11a and 11b of the telecentric lens 11, the peak of curve 15a is around 13 degrees and the highest AOI is about 38 degrees, while in FIG. 3b), in the case where the wavelength filter 12 is positioned between the photo detector 5 and the telecentric lens 11, the peak of curve 15b is around 10 degrees and the largest AOI is about 30 degrees, which means that in this example the optical stack 4b and the associated position of the wavelength filter 12 is better than in the case of the optical stack 4a.

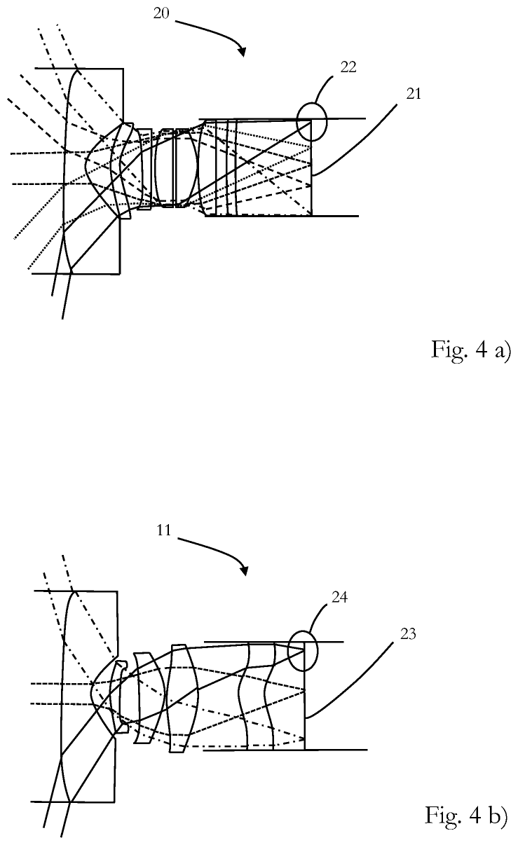

FIG. 4 illustrates differences between a common lens system 20 illustrated in FIG. 4a) (upper side) and the telecentric lens 11 illustrated in FIG. 4b) (down side).

The common lens system 20 focuses incoming light (from the left side) to an optical plane 21, where typically an image sensor is provided. As can be taken from FIG. 4a), in a region 22, which is at an edge of the plane 21 where the light rays are focused, the AOI is increased compared, for example, to the center. In contrast to this, in the case of the telecentric lens 11, which focuses incoming light to a plane 23, in a region 24, which is at the edge of the plane 23, the AOI does not change as strongly as it is the case for the common lens system 20, but the AOI increase is much smaller compared to the common lens system 20.

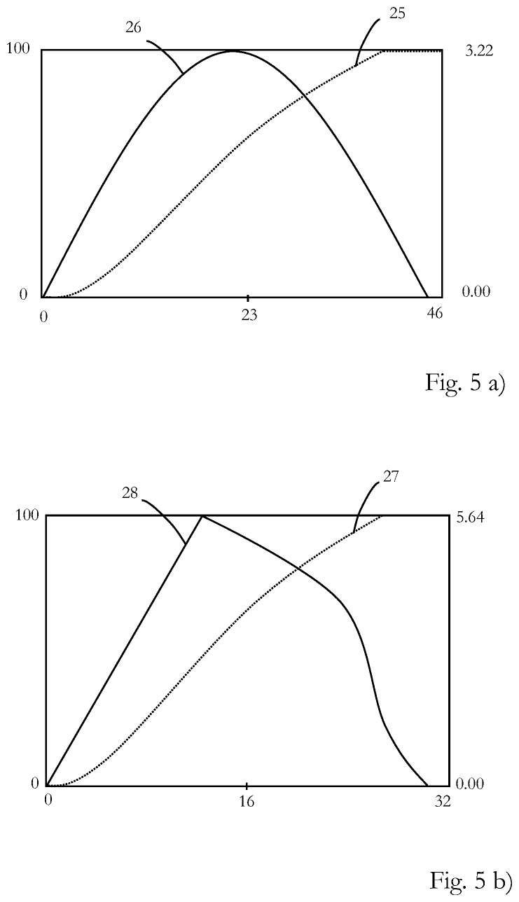

FIG. 5. illustrates on the upper side, FIG. 5a), the AOI distribution for the common lens system 20 of FIG. 4a) and on the down side the AOI distribution for the case of the telecentric lens of FIG. 4b). Each of the Figs. shows on the abscissa the AOI, while on the left ordinate which is associated with curve 25 and 27, respectively, the cumulative percentage of measures rays is illustrated (from 0% to 100%) and on the right ordinate the percentage of rays at a specific AOI is illustrated, which is associated with the curves 26 and 28, respectively.

As can be taken from FIG. 5a), in the case of the common lens system 20, the peak of the AOI distribution curve 26 is at about 20 degrees and the maximum AOI is about 45 degrees, while in the case of the telecentric lens 11 of FIG. 5b), the peak of the AOI distribution curve 28 is at about 10 degrees and the maximum AOI is about 31 degrees, such that the telecentric lens 11 has a much better performance in that regard as the common lens system 20.

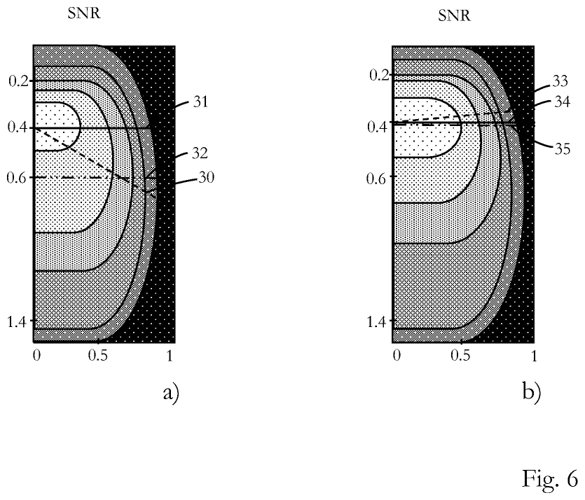

Furthermore, the wavelength filter itself can be adapted and, thus, optimized as will be explained under reference of FIG. 6, wherein FIG. 6a) on the left side refers to example using the common lens system 20 and FIG. 6b) on the right side refers to an embodiment using the telecentric lens 11.

For both cases, different wavelength filters are used, namely a first wavelength filter which is adapted to have a favoring performance in a center region, and a second wavelength filter which is adapted to have an average performance across the whole field of view, i.e. wherein the performance is balanced between the edge (boundary) regions and the center region.

FIGS. 6a) and 6b) each illustrate a heat map for a signal-to-noise ratio (SNR) distribution, wherein the abscissa shows the image height from “0” (left side) to “1”) (full diagonal) and the ordinate refers to a relative scaling of filtered infrared light compared to a model, and the brighter the hatching is, the higher is the percentage of transmitted infrared light. In this embodiment, also the brighter the hatching is, the higher the SNR, wherein here the SNR is the ratio between the active light intensity and the square root of the ambient light intensity which passes the wavelength filter.

A curve 30 in FIG. 6a) and a curve 33 in FIG. 6b) each show a theoretical best possible SNR (which can be derived on the basis of a model), curve 31 in FIG. 6a) and curve 34 in FIG. 6b), each show the SNR distribution for the first wavelength filter (“center performance”) and curve 32 in FIG. 6a) and curve 35 in FIG. 6b) each show the SNR distribution for the second wavelength filter (performance balanced between center and boundary region).

As can be taken from the comparison of FIG. 6a) and FIG. 6b), in the case of the first filter (see curve 34 compared to 31), the telecentric design has no performance improvement in the center region, but has a performance improvement, e.g. of 130%, in the corner regions (right side of FIG. 6b), the brighter region extends more to the right side than compared to FIG. 6a) for curves 31 and 34). In the case of the second filter, the telecentric design has overall better performance with an improvement, which may, e.g. range from 20% (center) to 65% (edge).

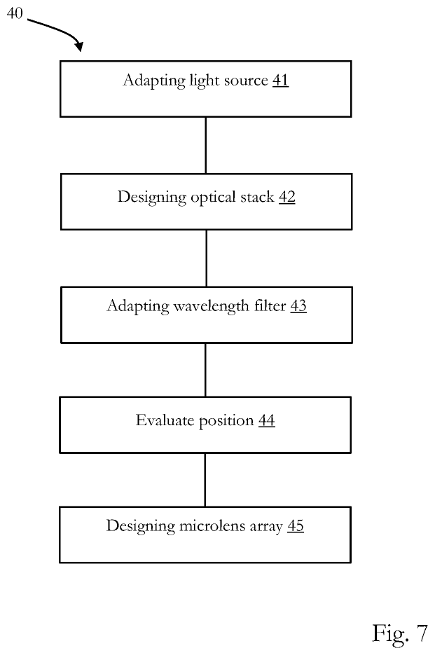

In the following, a method 40 for designing a ToF system, as described herein, will be discussed under reference of FIG. 7, wherein for illustration purposes it is assumed that the ToF system 1 of FIG. 1 is designed, without limiting the present disclosure in that regard.

In the following, the method 40 is based on designing and optimizing the following four elements, without limiting the present disclosure in that regard:

i) image-space telecentric lens 11 (FIG. 2) of the optical stack 4 (FIG. 1)
ii) wavelength IR filter 12 (FIG. 2), which can be selected adapted accordingly
iii) narrow band laser with minimal temperature dependency as light source 2
iv) microlens array 7 (which is designed to have no displacement compared to the pixel center)

As discussed herein, the method 40 takes into account to design the telecentric lens 11 (or the optical stack 4 including the telecentric lens 11) and then to determine correspondingly the transmission band of the wavelength filter 12, based on the ToF system 1 SNR evaluation. The design or optimization process takes into account the exact distribution of the cone of incidence of optical rays on the image sensor 6 (e.g. not only CRA (chief ray angles) or MRA (marginal ray angles)).

At 41, the method starts with adapting the light source 2 and determining the central wavelength which is emitted by the light source and determining and taking the temperature dependency of the light source into account. For instance, a light source 2 based on narrow band lasers is selected having a wavelength maximum ant 940 nm and its temperature dependency is determined. Moreover, the wavelength spectrum of the ambient light is taken into account such that the laser central wavelength optimization and the temperature dependency confine the active light in the IR wavelength filter passband.

At 42, the optical stack 4 including the telecentric lens is designed. The design target is a CRA distribution (AOI) of about zero degrees across the whole image height including a uniform distribution of the whole cone of incidence for every field point for the image sensor 6. Also the spectrum of the ambient light is taken into account for designing of the optical stack 4.

At 43, the wavelength filter 12 is adapted to the optical stack 4 and the light source 2 by designing a corresponding dimension and filtering characteristic based on the distribution of AOIs for each filed point of the image sensor 6, as also discussed, for example, under reference of FIG. 6 above.

Furthermore, at 44, the position of the wavelength filter 12 is evaluated within the optical stack 4 or after the optical stack to achieve a more confined cone of incident angles, e.g. the maximum AOI is reduced and the peak of the AOI is shifted to smaller AOIs as also explained under reference of FIGS. 2 and 3 above.

Hence, the optical stack 4 including the telecentric lens 11 and the (IR) wavelength filter 12 are co-designed to have the active light passing through the lens optimally using the filter bandwidth.

At 45, as mentioned, the microlens array 7 is designed such that it only copes with the pixel fill factor and minimizes optical cross talk.

After the design method 40 is finished, a corresponding time-of-flight system 1 is provided, since at least the parameters and characteristics of each of the components discussed are defined such that the components may be produced, manufactured, selected, adapted and/or designed accordingly.

In some embodiments, the method 40 is performed automatically based on a general-purpose computer or the like.

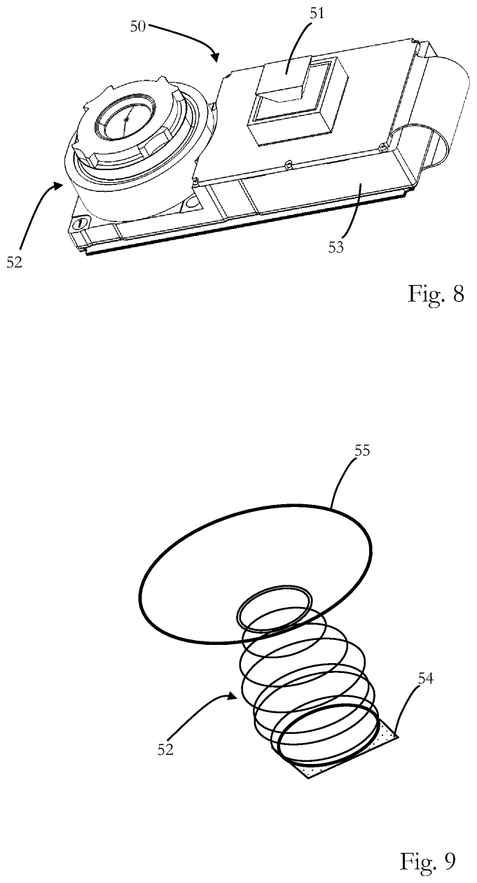

FIG. 8 illustrates a ToF camera 50, which exemplarily implements the functionality of the ToF system 1 of FIG. 1.

The ToF camera 50 has a light source 51 and a telecentric lens system 52 which are positioned next to each other in a common camera housing 53.

The light source 51 emits light and it has multiple light emitting elements based on laser diodes.

The telecentric lens system 52 collects light and corresponds, e.g., to the telecentric lens 11 of FIG. 3 above, and it also includes a wavelength filter (not shown), wherein the telecentric lens system 52 and the wavelength filter are adapted accordingly to each other as discussed herein.

FIG. 9 schematically illustrates the telecentric lens system 52 of the ToF camera 50 of FIG. 8, including an image sensor 54 of the ToF camera 50, wherein the image sensor 54 is based on multiple SPADs.

The top circle of FIG. 9 represents a cone 55 through which light rays enter the telecentric lens system 52 and are conducted onto the image sensor 54, wherein the following circles represent lenses of the telecentric lens system 52.

During operation of the ToF camera 50, the light source 51 emits light, which is reflected by an object, wherein the reflected light is collected by the telecentric lens system 52, and incidents on the image sensor 54, which generates an imaging signal based on the detected light.

By measuring the round-trip of the emitted light which is detected by the image sensor 54, a processor computes a distance between the ToF camera 50 and the object and, for example, the processor generates a depth map on the basis of which a three dimensional image of the object can be constructed.

The methods as described herein, in particular method 40, are also implemented in some embodiments as a computer program causing a computer and/or a processor and/or a circuitry to perform the method, when being carried out on the computer and/or processor and/or circuitry. In some embodiments, also a non-transitory computer-readable recording medium is provided that stores therein a computer program product, which, when executed by a processor, such as the processor described above, causes the methods described herein to be performed.

It should be recognized that the embodiments describe methods with an exemplary ordering of method steps. The specific ordering of method steps is however given for illustrative purposes only and should not be construed as binding. For example the ordering of 41 to 45 in the embodiment of FIG. 7 may be exchanged and any ordering of 41 to 45 is envisaged by the skilled person. Other changes of the ordering of method steps may be apparent to the skilled person.

Please note that the division of the circuitry 8 into units 9 and 10 is only made for illustration purposes and that the present disclosure is not limited to any specific division of functions in specific units. For instance, the circuitry 8 could be implemented by a respective programmed processor, field programmable gate array (FPGA) and the like.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) A time-of-flight apparatus, comprising:
a telecentric lens;
a wavelength filter; and
a light detection portion, wherein the wavelength filter is adapted to the telecentric lens.
   (2) The time-of-flight apparatus according to (1), wherein the wavelength filter is adapted to the telecentric lens, based on a predetermined signal-to-noise ratio value.
   (3) The time-of-flight apparatus of (1) or (2), wherein the wavelength filter is adapted based on a distribution of light rays transmitted from the telecentric lens onto light detection portion.
   (4) The time-of-flight apparatus of anyone of (1) to (3), further comprising a lens system, wherein the telecentric lens is part of the lens system and wherein a position of the wavelength filter is adapted, based on a predetermined signal-to-noise ratio value.
   (5) The time-of-flight apparatus of anyone of (1) to (4), wherein the wavelength filter is adapted, based on an angle of incidence caused by the telecentric lens.
   (6) The time-of-flight apparatus of anyone of (1) to (5), wherein the wavelength filter is adapted to be basically uniform.
   (7) The time-of-flight apparatus of (6), wherein the wavelength filter is adapted to be basically uniform in a boundary region.
   (8) The time-of-flight apparatus of anyone of (1) to (7), wherein the time-of-flight apparatus further includes a microlens array arranged on the light detection portion, wherein the microlens array has basically a uniform spacing.
   (9) The time-of-flight apparatus of anyone of (1) to (8), further comprising a light source, wherein the light source has a wavelength band which is adapted to the wavelength filter.
   (10) The time-of-flight apparatus of (9), wherein the light source includes at least one narrow band laser element.
   (11) A method for providing a time-of-flight system, wherein the time-of-flight system includes a telecentric lens, a wavelength filter and a light detection portion, the method comprising:
adapting the wavelength filter to the telecentric lens.
   (12) The method for providing a time-of-flight system of (11), wherein the wavelength filter is adapted to the telecentric lens, based on a predetermined signal-to-noise ratio value.
   (13) The method for providing a time-of-flight system of (11) or (12), wherein the wavelength filter is adapted based on a distribution of light rays transmitted from the telecentric lens onto light detection portion.
   (14) The method for providing a time-of-flight system of anyone of (11) to (13), wherein the time-of-flight system further includes a lens system, wherein the telecentric lens is part of the lens system and wherein the method further comprises adapting a position of the wavelength filter, based on a predetermined signal-to-noise ratio value.
   (15) The method for providing a time-of-flight system of anyone of (11) to (14), wherein the wavelength filter is adapted, based on an angle of incidence caused by the telecentric lens.
   (16) The method for providing a time-of-flight system of anyone of (11) to (15), wherein the wavelength filter is adapted to be basically uniform.
   (17) The method for providing a time-of-flight system of (16), wherein the wavelength filter is adapted to be basically uniform in a boundary region.
   (18) The method for providing a time-of-flight system of anyone of (11) to (17), wherein the time-of-flight system further includes a microlens array arranged on the light detection portion, wherein the microlens array has basically a uniform spacing.
   (19) The method for providing a time-of-flight system of anyone of (11) to (18), wherein the time-of-flight system further includes a light source, wherein the light source has a wavelength band, and wherein the method further comprises adapting the wavelength band to the wavelength filter.
   (20) The method for providing a time-of-flight system of (19), wherein the light source includes at least one narrow band laser element.
   (21) A computer program comprising program code causing a computer to perform the method according to anyone of (11) to (20), when being carried out on a computer.
   (22) A non-transitory computer-readable recording medium that stores therein a computer program product, which, when executed by a processor, causes the method according to anyone of (11) to (20) to be performed.

1. A time-of-flight apparatus, comprising:
a telecentric lens;
a wavelength filter; and
a light detection portion, wherein the wavelength filter is adapted to the telecentric lens.

2. The time-of-flight apparatus according to claim 1, wherein the wavelength filter is adapted to the telecentric lens, based on a predetermined signal-to-noise ratio value.

3. The time-of-flight apparatus of claim 1, wherein the wavelength filter is adapted based on a distribution of light rays transmitted from the telecentric lens onto light detection portion.

4. The time-of-flight apparatus of claim 1, further comprising a lens system, wherein the telecentric lens is part of the lens system and wherein a position of the wavelength filter is adapted, based on a predetermined signal-to-noise ratio value.

5. The time-of-flight apparatus of claim 1, wherein the wavelength filter is adapted, based on an angle of incidence caused by the telecentric lens.

6. The time-of-flight apparatus of claim 1, wherein the wavelength filter is adapted to be basically uniform.

7. The time-of-flight apparatus of claim 6, wherein the wavelength filter is adapted to be basically uniform in a boundary region.

8. The time-of-flight apparatus of claim 1, wherein the time-of-flight apparatus further includes a microlens array arranged on the light detection portion, wherein the microlens array has basically a uniform spacing.

9. The time-of-flight apparatus of claim 1, further comprising a light source, wherein the light source has a wavelength band which is adapted to the wavelength filter.

10. The time-of-flight apparatus of claim 9, wherein the light source includes at least one narrow band laser element.

11. A method for providing a time-of-flight system, wherein the time-of-flight system includes a telecentric lens, a wavelength filter and a light detection portion, the method comprising:
adapting the wavelength filter to the telecentric lens.

12. The method for providing a time-of-flight system of claim 11, wherein the wavelength filter is adapted to the telecentric lens, based on a predetermined signal-to-noise ratio value.

13. The method for providing a time-of-flight system of claim 11, wherein the wavelength filter is adapted based on a distribution of light rays transmitted from the telecentric lens onto light detection portion.

14. The method for providing a time-of-flight system of claim 11, wherein the time-of-flight system further includes a lens system, wherein the telecentric lens is part of the lens system and wherein the method further comprises adapting a position of the wavelength filter, based on a predetermined signal-to-noise ratio value.

15. The method for providing a time-of-flight system of claim 11, wherein the wavelength filter is adapted, based on an angle of incidence caused by the telecentric lens.

16. The method for providing a time-of-flight system of claim 11, wherein the wavelength filter is adapted to be basically uniform.

17. The method for providing a time-of-flight system of claim 16, wherein the wavelength filter is adapted to be basically uniform in a boundary region.

18. The method for providing a time-of-flight system of claim 11, wherein the time-of-flight system further includes a microlens array arranged on the light detection portion, wherein the microlens array has basically a uniform spacing.

19. The method for providing a time-of-flight system of claim 11, wherein the time-of-flight system further includes a light source, wherein the light source has a wavelength band, and wherein the method further comprises adapting the wavelength band to the wavelength filter.

20. The method for providing a time-of-flight system of claim 19, wherein the light source includes at least one narrow band laser element.
